(19) United States
(12) Patent Application Publication
(10) Pub. No.: US 2008/0101337 A1
(43) Pub. Date: May 1, 2008

(54) COMMUNICATIONS SYSTEM, LOCAL AREA COMMUNICATIONS NETWORK SYSTEM, THEIR NETWORK INTERFACE CHIPSET AND PHYSICAL LAYER CIRCUIT THEREOF

(76) Inventor: Tsu-Chun Liu, Hsin-Chu City (TW)

Correspondence Address: Venable LLP;Raymond J. Ho, 575 7th Street NW, Washington, DC, 20004-1601, US

(21) Appl. No.: 11/555,203

(22) Filed: Oct. 31, 2006

(51) Int. Cl. H04L 12/66

(52) U.S. Cl. 370/352

(57) ABSTRACT

A novel physical layer circuit enables the computer equipments in connection with the invented physical layer circuit to transmit and to receive data through the telephone cord. The physical layer circuit may be provided in a network interface chipset and comprises an encoder circuit, a transmitter circuit, a receiving filter, an analog to digital converter, a clock signal generator and a decoder circuit. The present invention also discloses the network interface chipset that contains the physical layer circuit, the local area communications system using the network interface chipset.

### FIELD OF THE INVENTION

The present invention relates to a new communications system, local area communications network system, their network interface chipset and the physical layer circuit of the network interface chipset, especially to a local area communications network that links a variety of computer equipments and peripherals to form a local area communications network system that transmits and receives high speed Ethernet packets using the existing telephone cords, the network interface chipset used in the local area communications network, the physical layer circuit of the network interface chipset and the communications system so made.

### BACKGROUND OF THE INVENTION

The rapid development of the network communication technology has made the network communication system a necessary facility of almost every family and business. Many types of network interface cards and network interface chipsets that connect the computer equipments are commercially available and provide the wired or wireless data transmission functions for users.

There are two major types of network interface cards and network interface chipsets. They are the wireless type and the broadband type. The broadband type provides cheaper and broader bandwidth communication services. It however requires the use of the bulky cables. When the network is installed, additional network cables are used to connect the network system. The cables are inconvenient to use and impact the interior decorations of the office and the home. The wireless network interface chipset uses no cables but is expensive. It provides limited bandwidth and requires a plurality of computer equipments to share the same bandwidth. In addition, the network security of the wireless network is always a concern to all users.

In addition to the above-mentioned types, using the power cords in the electric power supply system as the communication channels of the network system has been proposed. Such network system provides limited bandwidth under relatively higher costs. Although it uses the existing power supply system network, it is in the bus schematics and exhibits limited scalabilities. Another type of the network system uses the existing telephone cord system as the communication channels. The most popular product is the “home PNA” products. However, the home PNA products are not only expensive in cost but also provide the narrowest bandwidth among all the network systems. All these existing technologies are the “half-duplex” system.

If one looks at the existing network communication systems, one may come to the conclusion that the telephone cord system might be the best choice in order to serve as the communication channels for the network communication system. This is partly because the telephone cord system has been existing for decays, it's low-cost and has been already installed in almost every building. Hardware systems that enable the network communication system using the existing telephone cord system at relatively low costs are thus desirable.

### OBJECTIVES OF THE INVENTION

The objective of this invention is to provide a novel local area communications network system that uses the existing telephone cord system to conduct the network communications.

Another objective of this invention is to provide a physical layer circuit that connects the telephone cord and the computer equipment, whereby the computer may use the telephone cord to transmit and to receive data.

Another objective of this invention is to provide a physical layer circuit that uses the telephone cord system as the network communication system and works with the popular Ethernet MAC layer and their technologies.

Another objective of this invention is to provide a communications system, a local area communications network system and their network interface chipset that use the physical layer circuit of the present invention.

### SUMMARY OF THE INVENTION

According to the present invention, a novel physical layer circuit that enables the computer equipments that use a network interface card or network interface chipset containing the invented physical layer circuit to transmit and to receive data through the telephone cord. The physical layer circuit may be provided in the network interface card or network interface chipset and comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The present invention also discloses a communications system, comprising at least one telephone cord and physical layer circuits that are in connection with the respective two terminals of said telephone cord and are provided in respectively network interface chipsets for local area network. The physical layer circuit may be provided in said network interface chipset or network interface card containing said network interface chipset. The physical layer circuit of the present invention enables the computer systems that are in connection with the network interface chipsets to transmit and to receive data through the telephone cord. The invented physical layer circuit comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The present invention also provides a local area communications system that comprises at least one telephone cord and physical layer circuits that are in connection with the respective two terminals of said telephone cord and are provided in respectively network interface chipsets for the local area communications network. The physical layer circuit may be provided in the network interface chipset or a network interface card containing the network interface chipset. The physical layer circuit of the present invention enables the computer systems that are connected with the network interface chipsets to transmit and to receive data in full duplex or in half duplex through the telephone cord. The physical layer circuit of the invented local area communications system comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The present invention also discloses the network interface chipset for a local area communications system. The network interface chipset comprises at least two physical layer circuits and a data exchange circuit connecting said two physical layer circuits. The physical layer circuit may be provided in the network interface chipset or a network interface card containing said network interface chipset. The physical layer circuit of this invention enables the computer systems that are connected with the network interface chipsets to transmit and to receive data through a telephone cord and comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The data exchange circuit may be any device that transmits data from a physical layer circuit to a particular physical layer circuit and may be a hub, a switch, a router or a gateway.

The present invention also discloses a communications system, comprising at least one telephone cord and network interface chipsets connected with the two terminals of said telephone cord. The network interface chipset comprises at least two physical layer circuits and a data exchange circuit connecting said at least two physical layer circuits. The physical layer circuit may be provided in said network interface chipset or in a network interface card containing said network interface chipset. The physical layer circuit enables the computer systems that are connected with the network interface chipsets to transmit and to receive data through the telephone cord and comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The data exchange circuit may be any device that transmits data from a physical layer circuit to another particular physical layer circuit and may be a hub, a switch, a router or a gateway.

The present invention also discloses a local area communications network system, comprising at least one telephone cord and network interface chipsets connected with the two terminals of said telephone cord. The network interface chipset comprises at least one physical layer circuit and a data exchange circuit connecting said at least two physically layer circuits. The physical layer circuit may be provided in said network interface chipset or a network interface card containing said network interface chipset. The physical layer circuit enables the computer systems that are connected with the network interface chipsets to transmit and to receive data through the telephone cord and comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The data exchange circuit may be any device that transmits data from a physical layer circuit to another particular physical layer circuit and may be a hub, a switch, a router or a gateway.

The present invention also discloses a local area communications network system, comprising at least one telephone cord and network interface cards connected with the two terminals of said telephone cord. The network interface card comprises at least two physical layer circuits and a data exchange circuit connecting said two physical layer circuits. The physical layer circuit may be provided in said network interface card. The physical layer circuit enables the computer systems that are connected with the network interface card to transmit and to receive data through the telephone cord and comprises:

an encoder circuit to encode signals to be transmitted in a particular format for transmission;

a transmitter circuit to supply said encoded signals to a telephone cord in an electric form;

a receiving filter, connected with said telephone cord, to receive input signals and to filter noises from said received signals;

an analog to digital converter to convert said input signals which are analog signals into digital codes;

a clock signal generator to generate clock signals for said analog to digital converter; and

a decoder circuit to decode said codes generated by said analog to digital converter into electric signals.

The data exchange circuit may be any device that transmits data from a physical layer circuit to another particular physical layer circuit and may be a hub, a switch, a router or a gateway.

According to the present invention, the invented physical layer circuit may be provided in a network interface card or a network interface chipset, to enable the computer systems that are in connection with the network interface card to transmit and to receive data through a telephone cord. A plurality of the invented physical layer circuits may be provided in combination with a plurality of MAC (media access control) layer circuits in a hub, a switch, a router, a gateway etc. Telephone cords may be connected with the assembly so obtained and the full duplex or half duplex point-to-point network communications through the telephone cord using the obtained assembly may be realized. A plurality of the assembly containing the invented physical layer circuit may be connected to form a network communications system that uses the telephone cord as the channels of the communications system. If necessary, the number of the telephone cord and the physical layer circuit may be unlimitedly added. A convenient, low-cost and scalable network communications system is thus realized.

These and other objectives and advantages of this invention may be clearly understood from the detailed description by referring to the following drawings.

### BRIEF DESCRIPTION OF THE DRAWINGS

FIG. 1 shows the systematic diagram of the local area network communications system of the present invention.

FIG. 2 illustrates the block diagram of the network interface chipset for local area network system of the present invention.

### DETAILED DESCRIPTION OF THE INVENTION

In the followings several embodiments of the present invention will be described to illustrate the applications of this invention. The detailed descriptions of the invention shall not be used to limit its scope of protection.

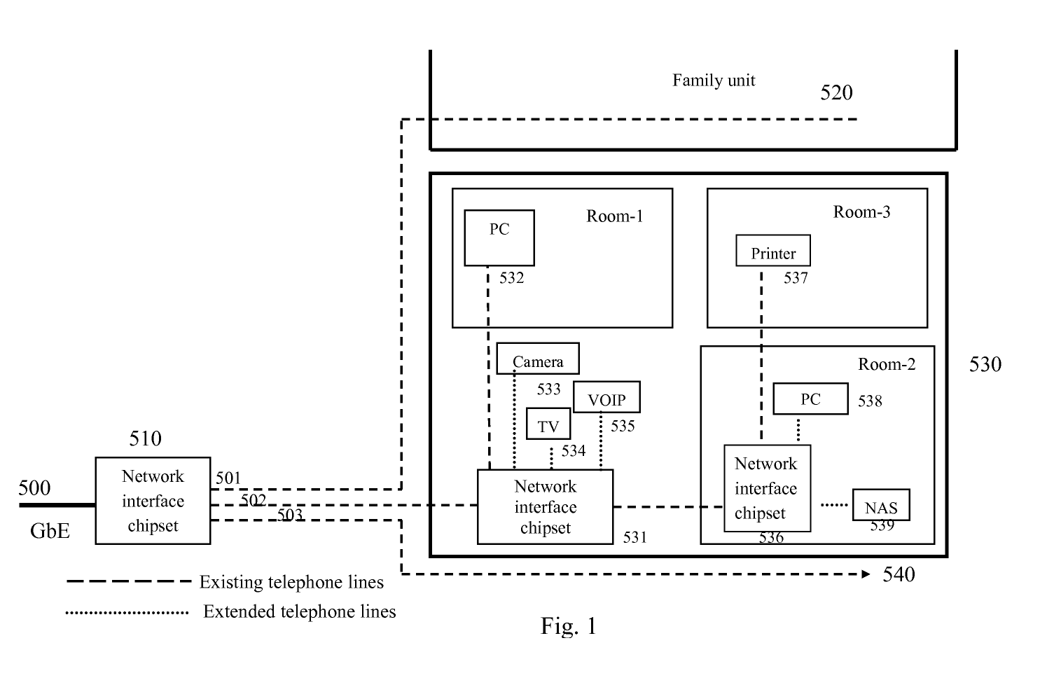

FIG. 1 shows the systematic diagram of the local area network communications system of the present invention. FIG. 1 illustrates how the physical layer circuit is used in the network interface chipset of a local area network, in the case of the local area network of a family. For those skilled in the art, it is easy to understand that the invented physical layer circuit, the invented network interface chipset and the local area network may be used in any type of organization or non-organization complex.

As shown in the figure, a broadband loop 500, which may be a copper cable or an optical fiber, is introduced from the outside and is connected at the first contact, i.e., the first physical layer circuit (not shown), of the network interface chipset 510 of the local area network system. The other end of the loop may be the computer system of the system service provider of a high-speed broadband network, where the contact also includes the network interface chipset (not shown) of this invention or other suited transmission and receiving devices. The figure also shows that the network interface chipset 510 of the local area system is in connection with three family units 520, 530 and 540 through three local telephone cords 501, 502 and 503.

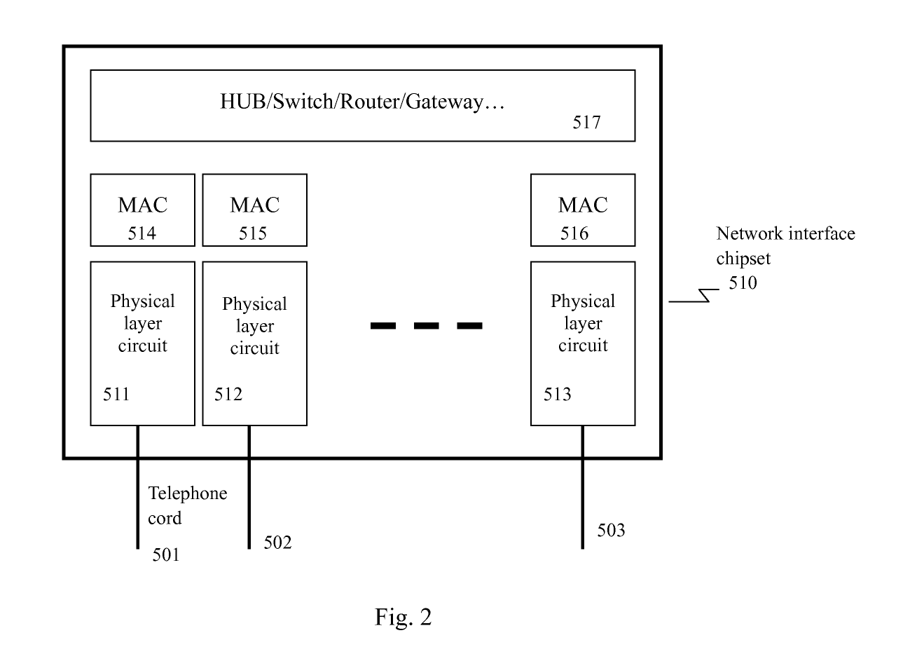

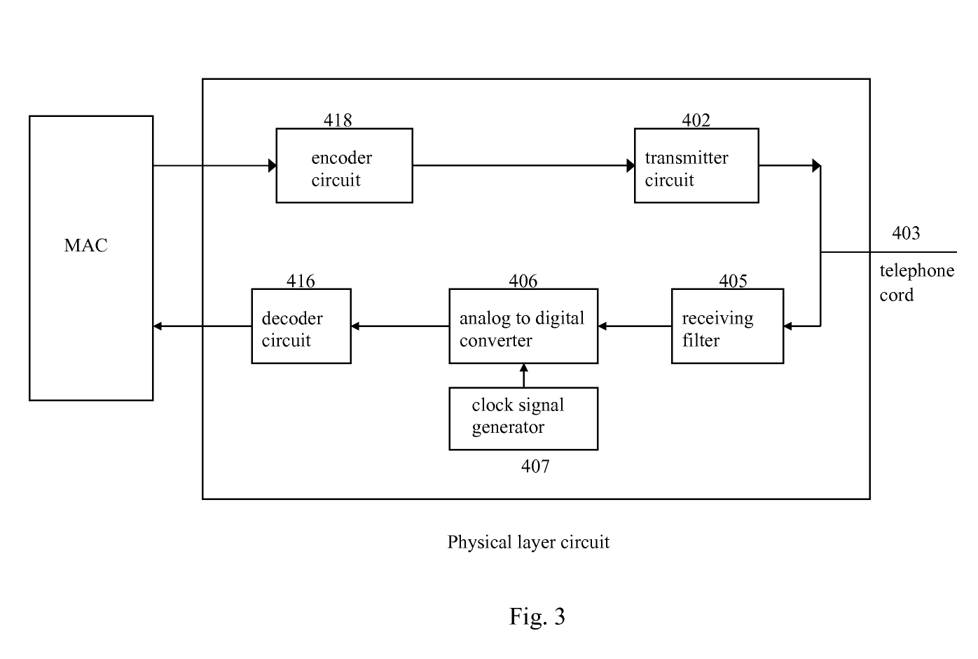

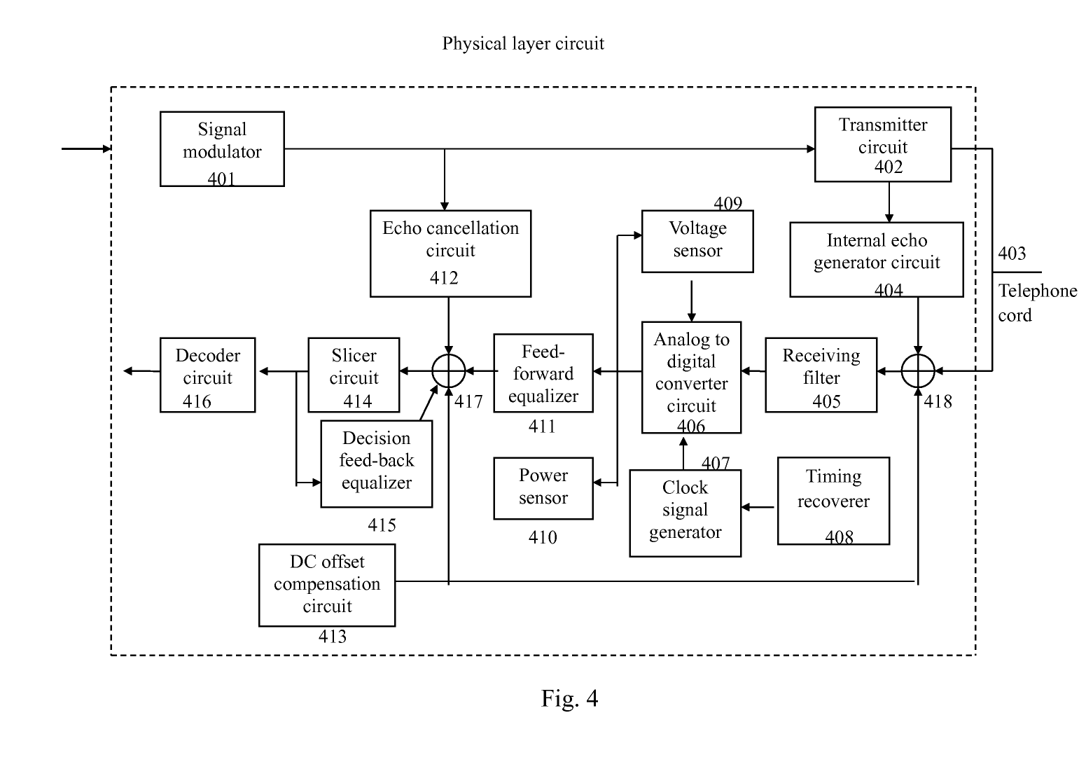

FIG. 2 illustrates the block diagram of the network interface chipset for local area network system of the present invention. As shown in this figure, the network interface chipset of the present invention has a switch fabric 517, several physical layer circuits 511, 512 and 513 and MAC's 514, 515 and 516 in the same number of the physical layer circuits. The telephone cords 501, 502 and 503 introduced from outside are connected with the respectively corresponding physical layer circuits 511, 512 and 513. Pulse signals, always voltage signals, transmitted into the local area network through the telephone cords 501, 502 and 503 are converted into electronic signals by the physical layer circuits, decoded and forwarded to the MAC's 514, 515 and 516, respectively. They are then forwarded to the switch circuit 517, so that they may be transmitted to the corrected destinations, via the selected assemblies of physical layer circuit and MAC and the telephone cords connected thereto. In the present invention, the switch circuit 517 may be a router or a gateway. The major function of the switch circuit 517 is to correctly deliver the electronic signals to a plurality of communications networks. For those skilled in the art, it is clear that any type of the switching circuit may be used in this invention to provide the similar functions.

Now refer to FIG. 1. The telephone cords of the local are network that connects the network interface chipset 510 extend to the respective family units 520, 530 and 540 and connect with the network interface cards or network interface chipsets of the corresponding family units. As shown in the figure, the other contacts of the network interface chipset 531 are in connection with telephone cords, which in turn are in connection with a personal computer 532, a camera 533, a TV set 534, an internet phone 535 and the network equipment 536 located at another room. As described above, the structure of the network interface chipset 531 is identical to, similar with or compatible to the said network interface chipset 510. The only possible differences between them are in the number of ports being connected or the type of the device, a router, a switch, a hub, a gateway or the like. In addition, the personal computer 532 locates at the first room and the latter network interface chipset 536 locates at the second room and is in connection with the printer 537 in the third room, the computer 538 and the NAS (network access storage) 539 in the second room. Among them, the network interface chipset 536 has the same or similar structure as described above. Details thereof are thus omitted. In addition, the connection lines that connect the computer equipments and the network equipments are telephone cords in this embodiment. It is understood that all or a part of the telephone cords may be replaced by other types of connection lines. When a connection line is not a telephone cord, the physical layer circuit needs certain modifications accordingly. However, the main objective of the present invention is to use the telephone cord as at least a part of the connection lines of the local area communications system.

FIG. 3 shows the block diagram of the physical layer circuit for network interface chip of local area communications network system of this invention. As shown in the figure, the physical layer circuit is provided in the network interface chip for local area network system or in the network interface card that contains such chipset(s), in order to facilitate the computer equipments that are in connection with the network interface chipset to transmit and receive data through the telephone cords 403. The physical layer circuit comprises:

An encoder circuit 418 to encode signals to be transmitted in a particular format for transmission;

A transmitter circuit 402 to supply said encoded signals to a telephone cord in an electric form;

A receiving filter 405, in connection with said telephone cord, to receive input signals and to filter noises from said received signals;

An analog to digital converter 406 to convert said input signals which are analog signals into digital codes;

A clock signal generator 407 to generate clock signals for said analog to digital converter; and

A decoder circuit 416 to decode said codes generated by said analog to digital converter into electric signals.

FIG. 4 illustrates the detailed block diagram of the physical layer circuit for network interface chip of local area network system of this invention. In the figure an example of the physical layer circuit for network interface chip of local area network system useful in the present invention is shown. The schematics of the physical layer circuit for network interface chip of local area network system of the present invention include, at the transmission side:

A signal modulator 401 to modulate electronic signals input from the MAC into voltage signals and to add error control in the input signals due to the transmission or the modulation, such that the signals are suited for transmission in the communications network. The modulator 401 may be, for example, a Trellis code modulator or other suited modulation circuits.

A transmitter circuit 402 to receive said modulated voltage signals and to send them to a telephone cord 403, whereby the signals are transmitted to a remote destination through the telephone cord. The transmitter circuit that is useful in the present invention may be a digital to analog converter or a transmission filter. These circuits are known to those skilled in the art and detailed descriptions thereof are omitted.

A first internal echo generator circuit 404 to generate echo signals to offset the external echo voltages in the voltage signals generated by the transmitter circuit 402. After the offset, the residues are then canceled by the echo cancellation circuit 412. This is because a pair of telephone cords is used to support the full duplex signal transmission, the signals being transmitted would return to the receiving circuit which forms a pair with the transmitter of the signals. The echo thus needs to be cleared. Suited echo cancellation circuit includes any commercially available products. The signals after the above-mentioned processing are transmitted through the telephone cord 403.

At the receiving side, the following components are provided:

A filter 405 in connection with the telephone cord 403 to receive signals input from the external through the telephone cord 403. The filter 405 filters the noises from the signals to obtain the effective components of the signals. Generally speaking, the filter used in this circuit may be a commercially available low pass filter. Of course, other filters may also be used in the present invention, as long as they may fetch the data components in the input signals correctly.

An analog to digital converter circuit 406 to convert the received signals into digital voltage signals. The converter 406 may be any known art or circuit, for example those commercially available gain variable control analog to digital converters.

A clock signal generator 407 to provide a clock signal to the analog to digital converter circuit, so that the digital signals generated by the analog to digital converter may be electronic signals in a proper form. The clock signal generator 407 may be a PLL (phase lock loop) or any circuit that may generate stable clock signals. Generally speaking, it is possible to use a timing recoverer 408 to regulate the frequencies and phases of the clock signals.

A voltage sensor 409 to detect the output voltages of the analog to digital converter circuit 406, to ensure that the analog to digital converter 406 operates normally.

A power sensor 410 to detect the power of the received signals, to determine whether the communications line is connected or disconnected from the power of the received signals.

A feed-forward equalizer 411 to reduce the inter-symbol interference among the received symbols.

A digital echo cancellation circuit 412 to reduce the echoes in the received signals according to the signals having been transmitted which are known.

A DC offset compensation circuit 413 to conduct the DC offset compensation in the received signals; so that the DC signals missing in the transmission may be compensated.

A slicer 414 to slice the receive signals after they are operated, in order to determine the digital symbols represented by the received signals. The slicer circuit 414 may be any known slicer circuit. For example, it is possible to set the digital symbols of the transmission signals to be 1, 0 and −1. If the result of the operation is greater than 0.5, the corresponding signal is determined as 1. If the result is between −0.5 and 0, the signal is determined as 0 and if smaller than −0.5, it is determined as −1.

A decision feed-back equalizer 415 to fetch the signals having been sampled by the slicer 414 and feed back the signals to node 417. The signals are added with the outputs of the feed-forward equalizer 411 and the digital echo cancellation circuit 412, then fed to the slicer 414. And

A decoder 416 to decode the signals that are sliced by the slicer 414 in the predetermined manners, whereby the signals are recognizable by the downstream circuits. The decoder 416 may be any conventional decoder, using any known decoding rules. However, the Viterbi decoder is preferable in the present invention, so that the invented system is compatible with other communications systems. Of course, in particular circumstances, other decoder or decoding rules are used. It is also possible to use custom design decoding technologies. The results of the decoding are fed to the MAC circuit.

A circuit with the structure as described above processed the signals in the following manners:

The signals input from the telephone cord 403 are filtered by the first filter 405 and the data components are obtained. The signals, which are analog signals, are converted into digital signals by the analog to digital converter 406 and sampled based on the clock signals generated by the clock signal generator 407. The signals are then equalized by the equalizer 411, sliced by the slicer 414. The signals so obtained are sent to the decoder circuit 416 and the content of the signals are obtained. The signals are thus in the form that may be processed by the computer equipments. These signals are fed to the MAC circuit (FIG. 2) to be deframed. The results are forwarded to the hub, switch, router or gateway, to be forwarded to the MAC circuits of destination, wherein the signals are framed and are forwarded to the corresponding physical layer circuits.

The signals to be transmitted are electronic signals. The signals enter the physical layer, modulated into voltage signals by the modulator 401 and forwarded to the telephone cord 403 by the transmitter circuit 402, for being transmitted to the computer equipment, communications equipments or peripherals in connection with the telephone cord 403.

The circuit as described above may be connected at the two terminals of the telephone cord of the existing fixed telephone system to perform the full duplex or half duplex data exchange correctly, without the need of the special network cables. At the terminal of the telephone cord, the network interface chipset may provide a plurality of physical layer circuits and corresponding number of MAC circuits, plus applicable hubs, switches, routers and/or gateways. The network interface chipset may easily connect other communications terminals through the telephone cord or other connections, wired or wireless. A local area network with the structure as described above may use the telephone cord in all or a part of its communication lines, in combination with communications lines or wireless channels. The resulted communications system is low-cost, expandable and modular.

It is also possible to use a plurality of the invented physical layer circuits in combination with a plurality of MAC layer circuits in a hub, switch, router or gateway. The assembly is connected with an ordinary telephone cord to enable the terminal to terminal network communications. The whole system may be organized into a local area network to provide the convenient and economic full broadband network communications services. As it is possible to add the number of the telephone cord by adding the number of the physical layer circuits, the number of the telephone cords to be in connection is almost unlimited. A scalable communications system is thus realized.

As the present invention has been shown and described with reference to preferred embodiments thereof, those skilled in the art will recognize that the above and other changes may be made therein without departing from the spirit and scope of the invention.

What is claimed is:

1. A physical layer circuit, provided in the network interface chipset of a local area communications network system to allow computer equipments in connection with said network interface chipset to transmit and to receive data through a telephone cord connected thereto, wherein said physical layer comprises:
a encoder circuit to encode signals to be transmitted into codes of a suited format for transmission;
an transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

2. A communications system, comprising at least one telephone cord and physical layer circuits in connection with the two ends of said telephone cord; wherein each of said physical layer circuits is provided the network interface chipset of a local area network, allowing computer equipments in connection with said network interface chipset to transmit and to receive data through said telephone cord, and comprises:
an encoder circuit to encode signals to be transmitted into codes of a suited format for transmission;
a transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

3. A local area communications network system, comprising at least one telephone cord and physical layer circuits in connection with the two ends of said telephone cord, wherein said physical layer circuit is provided in a network interface chipset of said local area communications network system, allowing computer equipments in connection with said network interface chipset to transmit and to receive data in full duplex or half duplex through said telephone cord, and comprises:
an encoder circuit to encode signals to be transmitted into codes of a suited format for transmission;
a transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

4. A network interface chipset for local area communications network systems, comprising at least two physical layer circuits and a data exchange circuit in connection with said at least two physical layer circuits; wherein said data exchange circuit transmits data incoming from one said physical layer circuit to a designated physical layer circuit and wherein said physical layer circuit allows computer equipments in connection with said network interface chipset to transmit and to receive data through a telephone cord and comprises:
an encoder circuit to encode signals to be transmitted into codes of a suited format for transmission;
a transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

5. The network interface chipset according to claim 4, wherein said data exchange circuit comprises one selected from the group consisted of a hub, a switch, a router and a gateway.

6. A communications system, comprising at least one telephone cord and network interface chipsets in connection with the two ends of said telephone cord; wherein said network interface chipset comprises at least one physical layer circuit and a data exchange circuit in connection with said at least two physical layer circuits; wherein said data exchange circuit transmits data incoming from one said physical layer circuit to a designated physical layer circuit and wherein said physical layer circuit allows computer equipments in connection with said network interface chipset to transmit and to receive data through a telephone cord and comprises:
an encoder circuit to encode signals to be transmitted into codes of a suited format for transmission;
a transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

7. The communications system according to claim 6, wherein said data exchange circuit comprises one selected from the group consisted of a hub, a switch, a router and a gateway.

8. A local area communications network system, comprising at least one telephone cord and network interface chipsets in connection with the two ends of said telephone cord; wherein said network interface chipset comprises at least two physical layer circuits and a data exchange circuit in connection with said at least two physical layer circuits; wherein said data exchange circuit transmits data incoming from one said physical layer circuit to a designated physical layer circuit and said physical layer circuit allows computer equipments in connection with said network interface chipset to transmit and to receive data through a telephone cord and comprises:
an encoder circuit to encode signals to be transmitted into codes of a suited format for transmission;
a transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

9. The local area communications network system according to claim 8, wherein said data exchange circuit comprises one selected from the group consisted of a hub, a switch, a router and a gateway.

10. A local area communications network system comprising at least one telephone cord, a first network interface chipset in connection with one end of said telephone cord and a physical layer circuit in connection with the other end of said telephone cord and provided in a second network interface chipset; wherein said second network interface chipset comprises at least two said physical layer circuits and a data exchange circuit in connection with said at least two physical layer circuits; wherein said data exchange circuit transmits data incoming from one said physical layer circuit to a designated physical layer circuit and said physical layer circuit allows computer equipments in connection with said network interface chipset to transmit and to receive data through a telephone cord and comprises:
an encoder circuit to encode signals to be transmitted into codes of a suited format for transmission;
a transmitter circuit to forward said encoded signals to said telephone cord in the electrical format;
a receiving filter in connection with said telephone cord to receive incoming signals and to filter noises from said incoming signals;
an analog to digital converter to convert said incoming signals from the analog signals into the digital signals to form codes;
a clock signal generator to generate clock signals for said analog to digital converter; and
a decoder circuit to decode codes generated by said analog to digital converter into the electronic signals.

11. The local area communications network system according to claim 10, wherein said data exchange circuit comprises one selected from the group consisted of a hub, a switch, a router and a gateway.
